(19) United States
(12) Patent Application Publication
(10) Pub. No.: US 2026/0045626 A1
(43) Pub. Date: Feb. 12, 2026

(54) BATTERY MODULE AND MODULE HOUSING

(71) Applicant: SK ON CO., LTD., Seoul (KR)

(72) Inventors: Jeong Woo HAN, Daejeon (KR); Tae Gu LEE, Daejeon (KR); Chae Won NA, Daejeon (KR); Soo Geun PARK, Daejeon (KR); Gang U LEE, Daejeon (KR)

(21) Appl. No.: 19/019,518

(22) Filed: Jan. 14, 2025

(30) Foreign Application Priority Data
Jan. 16, 2024 (KR) 10-2024-0006837
May 8, 2024 (KR) 10-2024-0060664

(51) Int. Cl. H01M 50/342; H01M 50/204; H01M 50/271; H01M 50/502

(52) U.S. Cl. CPC H01M 50/3425; H01M 50/271; H01M 50/502; H01M 50/204; H01M 2200/20

(57) ABSTRACT

A battery module includes a cell assembly including a plurality of battery cells, a busbar assembly electrically connecting the plurality of battery cells, and a module housing accommodating the cell assembly including the plurality of battery cells and including a lower plate, a side cover, an upper case and a venting flap case covering a portion of an upper area of the upper case. The upper case includes at least one venting hole, and the venting flap case includes at least one discharge portion covering the venting hole and configured to be at least partially bent by pressure when an event occurs and open the venting hole.

### CROSS-REFERENCE TO RELATED APPLICATION(S)

This patent document claims the priority and benefits of Korean Patent Application No. 10-2024-0006837 filed on Jan. 16, 2024 and Korean Patent Application No. 10-2024-0060664 filed on May 8, 2024, the disclosures of which are incorporated herein by reference in their entirety.

### TECHNICAL FIELD

The disclosure and implementations disclosed in this patent document generally relate to a battery module and a module housing.

### BACKGROUND

Secondary batteries are one type of energy storage device that may be charged and discharged. Secondary batteries are widely used in various means that use electricity as a power source. For example, secondary batteries are used as energy storage devices in various means ranging from small devices such as mobile phones, laptops, and tablets to large devices such as vehicles and aircraft. In detail, secondary batteries have been actively explored as a vehicle power source recently.

Secondary batteries may be classified into lead-acid batteries, nickel-cadmium batteries, nickel-hydrogen batteries, lithium-ion batteries, and the like depending on a material of the electrode. Each type of secondary battery may be appropriately selected depending on the design capacity, usage environment, or the like. Alternatively, the secondary battery may be an all-solid-state battery that uses a solid electrolyte instead of a liquid electrolyte. Lithium-ion batteries may implement relatively high voltage and capacity compared to other types of secondary batteries. Accordingly, lithium-ion batteries are widely used in fields that require high-density energy storage devices such as vehicle battery packs.

Secondary batteries such as lithium-ion batteries may include a cathode, an anode, a separator, an electrolyte, and the like. The cathode and the anode are disposed with an insulating separator therebetween, and charging or discharging may be performed by the movement of ions through the electrolyte.

Secondary batteries are manufactured as flexible pouch-type battery cells or as rigid prismatic or cylindrical can-type battery cells.

Cell assemblies are disposed inside a module housing to form a battery module, and a plurality of battery modules may be disposed inside a pack housing to form a battery pack.

In addition, recently, the formation of a battery module is omitted, and a Cell to Pack (CTP) method is used in which battery cells are directly integrated into a battery pack to connect the battery pack to a main body frame.

### SUMMARY

Meanwhile, in the case in which a thermal runaway or thermal propagation situation occurs in a battery module, high-pressure gas or flames may occur inside the module. The gas or flames may need to be properly discharged to the outside of the module. At this time, the gas or flames may occur in a local area of the module, and it may need to prevent the gas or flames from spreading to other battery cells within the module or adjacent modules through appropriate discharge thereof.

The present disclosure may be implemented in some embodiments to provide a battery module and a module housing, in which manufacturing and management costs of the battery module may be reduced.

According to an aspect of the present disclosure, gas, foreign objects, or the like generated in a thermal runaway or thermal propagation situation in a battery module may be discharged in a timely manner.

According to an aspect of the present disclosure, external foreign objects may be prevented from penetrating into a battery module through a venting hole.

A battery module and a module housing according to an aspect of the present disclosure may be widely applied to devices within green technology fields such as electric vehicles, battery charging stations, and solar power generation and wind power generation using batteries. In addition, a secondary battery and a battery module according to an aspect of the present disclosure may be used in eco-friendly electric vehicles, hybrid vehicles, and the like to prevent climate change by suppressing air pollution and greenhouse gas emissions.

In some embodiments of the present disclosure, a battery module includes a cell assembly including a plurality of battery cells; a busbar assembly electrically connecting the plurality of battery cells; and a module housing accommodating the cell assembly and including an upper case and a venting flap case covering a portion of an upper area of the upper case. The upper case includes at least one venting hole, and the venting flap case includes at least one discharge portion covering the venting hole and configured to be at least partially bent by pressure when an event occurs and open the venting hole.

The discharge portion may include a discharge plate covering the venting hole and larger than the venting hole; a folded portion provided on one side of the discharge plate and configured to be bent to move the discharge plate; and a slit provided by cutting or punching a perimeter of the discharge plate excluding the folded portion.

The discharge plate may include a quadrangular shape, the slit may be provided along three sides of the discharge plate, and the folded portion may be provided on another one side.

The folded portion may further include a notched portion at least partially cut or punched to facilitate bending.

The folded portion may be configured to be bent at an angle between the discharge plate and the upper case when the event occurs, less than 90 degrees.

The venting flap case may include a welded portion welded to the upper case.

The discharge portions adjacent to each other may share at least a portion of the slit.

The welded portion may be spaced apart from the folded portion and formed in a line along the folded portion.

The venting flap case may include any one of aluminum series, steel series, ceramic series, heat-resistant engineering plastic series and carbon fiber reinforced plastic series materials.

A thickness of the venting flap case may be 0.01 millimeters (mm) or more and 3 mm or less.

The venting holes may be respectively the same size, and the discharge portions may be respectively the same size.

A thickness of the venting flap case may be less than or equal to 0.3 mm.

The venting hole may include a relatively short venting hole and a relatively long venting hole, and the discharge portion may include a relatively short discharge portion and a relatively long discharge portion.

A thickness of the venting flap case may be greater than or equal to 0.3 mm.

The cell assembly may further include a blocking member disposed above the plurality of battery cells.

The busbar assembly may include a connecting plate disposed above the cell assembly.

In some embodiments of the present disclosure, a battery module includes a first sub-module and a second sub-module each including a cell assembly including a plurality of battery cells and a busbar assembly electrically connecting the plurality of battery cells; and a module housing accommodating the first sub-module and the second sub-module, and including an upper case and a venting flap case covering a portion of an upper area of the upper case. The upper case may include at least one venting hole, and the venting flap case includes at least one discharge portion covering the venting hole and configured to be at least partially bent by pressure when an event occurs and to open the venting hole.

The module housing may further include a lower plate covering lower portions of the first sub-module and the second sub-module, and the upper case may cover upper portions of the first sub-module and the second sub-module.

The venting hole may include a first venting hole located on an upper portion of the first sub-module and a second venting hole located on an upper portion of the second sub-module, and the venting flap case may include a first venting flap case covering the first venting hole and a second venting flap case covering the second venting hole.

The discharge portion may include a discharge plate covering the venting hole and being larger than the venting hole; a folded portion provided on one side of the discharge plate and configured to be bent to move the discharge plate; and a slit provided by cutting or punching a perimeter of the discharge plate excluding the folded portion.

In some embodiments of the present disclosure, a module housing includes an upper case; and a venting flap case covering a portion of an upper area of the upper case. The upper case includes at least one venting hole. The venting flap case includes at least one discharge portion covering the venting hole and configured to be at least partially bent by pressure when an event occurs and to open the venting hole.

The discharge portion may include a discharge plate covering the venting hole and larger than the venting hole; a folded portion provided on one side of the discharge plate and configured to be bent to move the discharge plate; and a slit provided by cutting or punching a perimeter of the discharge plate excluding the folded portion.

### BRIEF DESCRIPTION OF DRAWINGS

Certain aspects, features, and advantages of the present disclosure are illustrated by the following detailed description with reference to the accompanying drawings.

FIG. 1 is an exploded perspective view illustrating a battery module according to an embodiment.

FIG. 2A is a plan view illustrating an upper case and a venting flap case.

FIG. 2B is a bottom view illustrating an upper case and a venting flap case.

FIG. 3 is a cross-sectional perspective view taken along line I-I′ of FIG. 1.

FIG. 4A is a cross-sectional view taken along line I-I′ of FIG. 1.

FIG. 4B is a cross-sectional view taken along line I-I′ of FIG. 1.

FIG. 5 is a cross-sectional view illustrating a portion of a cross-section taken along line I-I′ of FIG. 1.

FIG. 6 is a plan view illustrating a modified example of an upper case and a venting flap case.

FIG. 7 is an exploded perspective view illustrating a battery module of another embodiment.

### DETAILED DESCRIPTION

Features of the present disclosure disclosed in this patent document are described by example embodiments with reference to the accompanying drawings.

Hereinafter, embodiments will be described with reference to the attached drawings. For convenience, in the following description, detailed descriptions of well-known components or components that may obscure the technical gist of the present disclosure are omitted.

The following embodiments are provided to more fully explain the present disclosure to those skilled in the art. The following embodiments are provided to help understand the present disclosure, and the technical idea of the present disclosure is not necessarily limited to the specific embodiments described below. It should be understood that the present disclosure broadly includes various types of equivalents, substitutes, conversions, and the like that implement the technical idea described in the following embodiments.

The terms used in the following embodiments are provided to more fully explain the specific embodiments from the perspective as above. Therefore, the terms used in the following embodiments should not be interpreted as reducing, limiting, or restricting the technical idea of the present disclosure.

In the following description, singular expressions may be interpreted to include plural unless clearly excluded in the context. In addition, the expression “includes” in the following description means that the configuration, component, operation, feature, step, number, and the like described in the description exist, and does not mean that the addition of one or more other configurations, components, operations, features, steps, numbers, and the like is excluded.

The secondary battery or battery cell described in this specification may include a battery that may be recharged or discharged. For example, the secondary battery may include a lead-acid battery, a nickel-cadmium battery, a nickel-hydrogen battery, a lithium-ion battery, and the like. This description mainly assumes that the secondary battery is a lithium-ion battery. However, it should be understood that the technical concepts described in this specification may be applied to other suitable types of batteries in addition to lithium-ion batteries.

Before going into the detailed description of the present disclosure, it should be noted that the terms or words used in the present specification and claims described below should not be interpreted as being limited to their conventional or dictionary meanings, and should be interpreted as having meanings and concepts that conform to the technical idea of the present disclosure based on the principle that the inventor may appropriately define the concept of the term to explain his or her own invention in the best possible way. Therefore, the embodiments described in this specification and the configurations illustrated in the drawings are only example embodiments and do not represent all of the technical ideas of the present disclosure, and thus it should be understood that there may be various equivalents and modified examples that may replace the embodiments and the configurations.

Hereinafter, example embodiments will be described in detail with reference to the attached drawings. At this time, it should be noted that the same components in the attached drawings are represented by the same symbols as much as possible. In addition, detailed descriptions of known functions and configurations that may obscure the gist of the present disclosure will be omitted. For the same reason, some components in the attached drawings are exaggerated, omitted, or schematically illustrated, and the size of each component may not fully reflect the actual size thereof. For example, in this specification, expressions such as upper portion, upper side, upward, lower side, lower portion, downward, side surface, and the like are explained based on the diagram in the drawing, and may be expressed differently if the direction of the corresponding object is changed.

Hereinafter, the battery module and module housing in the present disclosure will be described in detail with reference to the drawings.

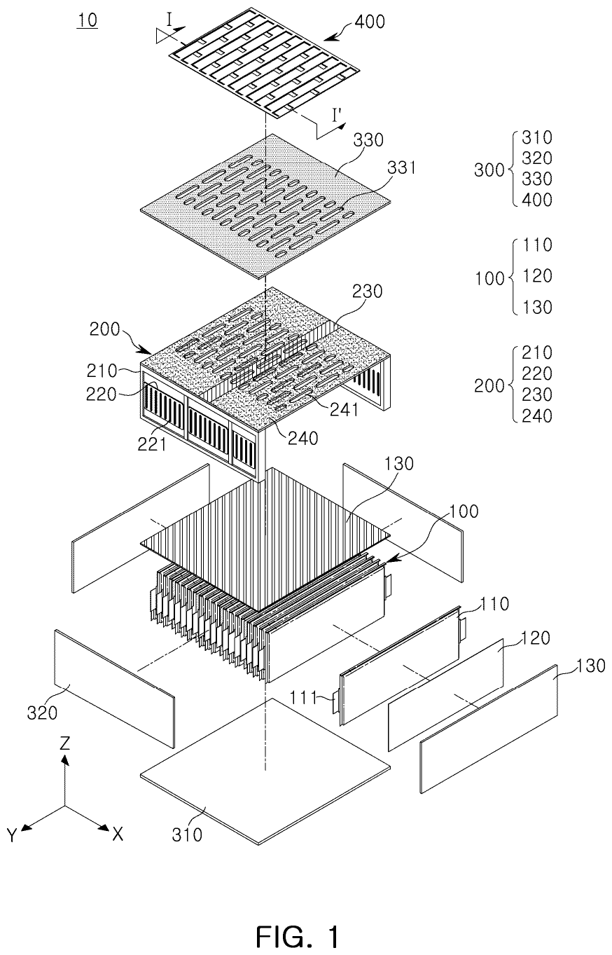

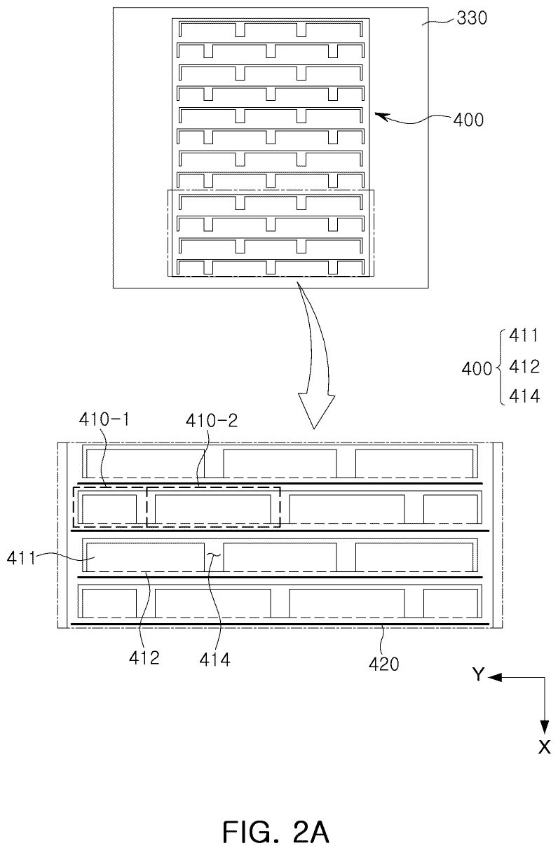

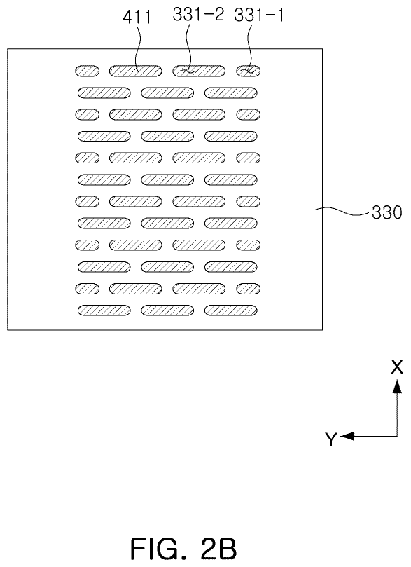

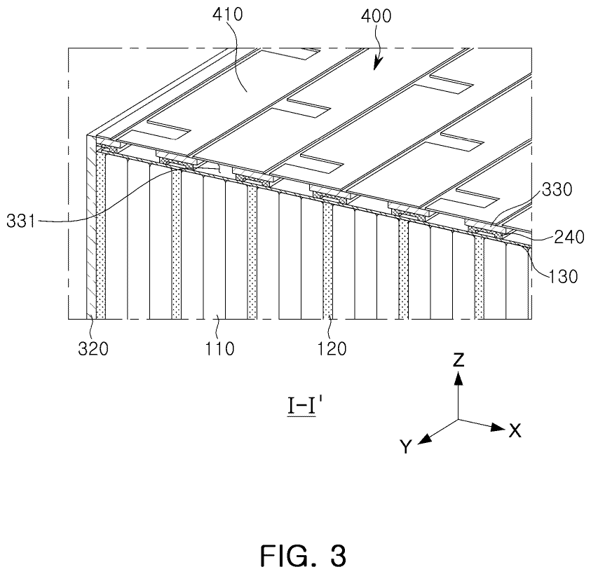

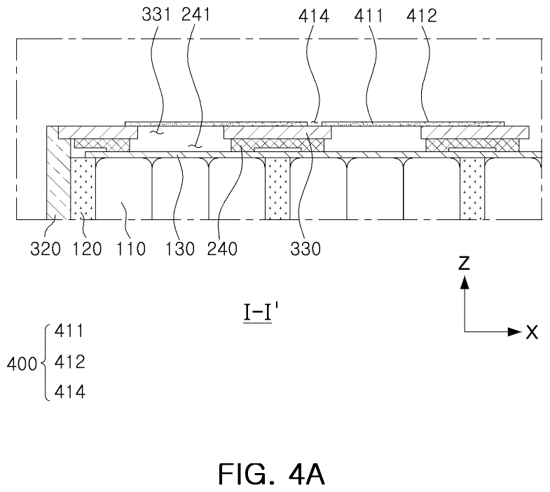

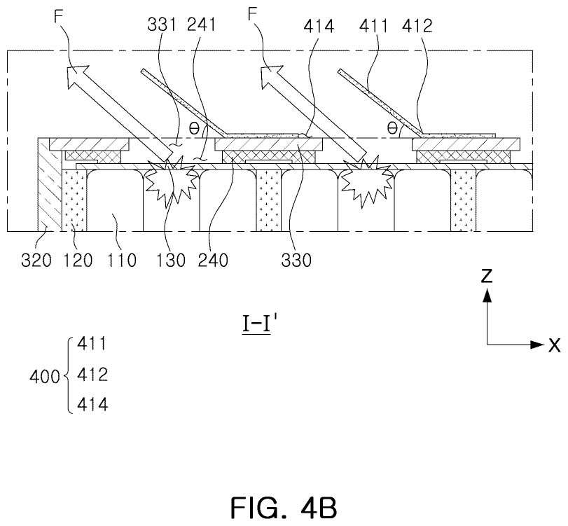

FIG. 1 is an exploded perspective view illustrating a battery module 10 of the present disclosure, FIG. 2A is a plan view illustrating an upper case 330 and a venting flap case 400, FIG. 2B is a bottom view illustrating the upper case 330 and the venting flap case 400, FIG. 3 is a cross-sectional perspective view taken along line I-I′ of FIG. 1, FIG. 4A is a cross-sectional view taken along line I-I′ of FIG. 1, and FIG. 4B is a cross-sectional view taken along line I-I′ of FIG. 1.

FIG. 2A and FIG. 2B illustrate a state in which an upper case 330 and a venting Flap case 400 are combined, FIG. 4A illustrates a state of a battery module 10 in normal times, and FIG. 4B illustrates a state of a battery module 10 when an event occurs.

Referring to FIG. 1 to FIG. 4B, the battery module 10 of the present disclosure may include a cell assembly 100, a busbar assembly 200, and a module housing 300.

The cell assembly 100 may include a plurality of battery cells 110. The plurality of battery cells 110 may be an assembly in which a plurality of battery cells 110 are assembled. At this time, the battery cells 110 may be arranged in a certain direction (X) and may be in a stacked state. Each battery cell 110 may output or store electrical energy.

The battery cell 110 may be formed of a lithium secondary battery, but is not limited thereto. For example, the battery cell 110 may be formed of various types of secondary batteries such as a nickel-cadmium battery, a nickel-metal hydride battery, and a nickel-hydrogen battery. The battery cell 110 may be formed of a pouch-type secondary battery. Hereinafter, a case in which a pouch-type secondary battery is used as the battery cell 110 will be described as an example. However, the present disclosure does not exclude the use of a can-type secondary battery such as a prismatic secondary battery or a cylindrical secondary battery as the battery cell 110.

The cell assembly 100 may further include a cell pad 120 and a blocking member 130.

The cell pad 120 may include a compressible pad and/or an insulating member. The compressible pad may be compressed and elastically deformed when a specific battery cell 110 expands, so that the entire volume of the cell assembly 100 may be suppressed from expanding. To this end, the compressible pad may be composed of a polyurethane foam, but a material or structure thereof is not limited thereto.

The insulating member may block flames or high-temperature heat energy from being transmitted between neighboring battery cells 110. Therefore, the insulating member may prevent a chain of ignition phenomena from occurring within the cell assembly. The insulating member may include a material having at least one or more properties among flames retardancy, heat resistance, heat insulation, and insulating properties. For example, the insulating member may include at least some of mica, silica, silicate, graphite, alumina, ceramic wool, and aerogel that may perform a heat and/or flames propagation prevention function.

The cell pad 120 may be respectively disposed between a certain number of battery cells 110. For example, referring to FIG. 4A and FIG. 4B, the cell pad 120 may be disposed every three battery cells 110. The spacing between the cell pads 120 may be appropriately adjusted.

The blocking member 130 may be disposed on top of the plurality of battery cells 110. The blocking member 130 may be disposed between the plurality of battery cells 110 and the connecting plate 240 or the upper case 330 to prevent flames from being discharged through the venting hole 331. The blocking member 130 may be disposed between the plurality of battery cells 110 and the connecting plate 240 or the upper case 330 to face the plurality of battery cells 110. For example, as illustrated in FIG. 4A and FIG. 4B, the blocking member 130 may cover the upper side of the plurality of battery cells 110.

The blocking member 130 may prevent or reduce flames generated inside the module housing 300 from spreading to other adjacent battery cells 110. In detail, the blocking member 130 may cover the upper portions of the plurality of battery cells 110, thereby preventing flames generated in one battery cell 110 from spreading to the upper portions of the adjacent other battery cells 110. In addition, the blocking member 130 may further include a hole having a shape corresponding to the venting hole 331 in a position corresponding to the venting hole 331, and in this case, the flames may be induced to be discharged to the outside through the venting hole 331 and prevented from spreading to the adjacent other battery cells 110. The blocking member 130 may include at least one of a porous metal foam and a metal mesh. The blocking member 130 may be formed of a flame-retardant, heat-resistant material. For example, the porous metal foam or the metal mesh may include a metal material having a melting point of 1000° C. or higher.

In addition, the blocking member 130 may perform the function of a heat-insulating member that blocks flames or high-temperature heat energy generated inside the module housing 300 from being transmitted to the outside. The blocking member 130 used as an insulating member may include at least some materials among mica, silica, silicate, graphite, alumina, ceramic wool, and aerogel.

In addition, the blocking member 130 may include a compressible material to absorb a tolerance that may occur between the plurality of battery cells 110 and the module housing 300. To this end, the blocking member 130 may be composed of a polyurethane foam.

However, the material of the blocking member 130 is not limited to the aforementioned materials, and various known configurations may be used.

The busbar assembly 200 may electrically connect the plurality of battery cells 110. The busbar assembly 200 may include an electrically conductive busbar 220 electrically connected to electrode leads 111 of the battery cells 110 and an electrically insulating busbar frame 210.

The busbar assembly 200 may be coupled to one or both sides of the battery cell 110 on which the electrode leads 111 are disposed. The busbar assembly 200 may be coupled to the electrode leads 111 in a direction (Y) perpendicular to the stacking direction (X) of the battery cells 110. The electrode leads 111 may pass through the busbar frame 210. The electrode leads 111 are electrically connected in series and/or in parallel by the busbar 220, on the outside of the busbar frame 210. To this end, coupling holes 221 through which the electrode leads 111 pass through and are coupled may be formed in the busbar 220. The connection between the electrode leads 111 and the bus bar 220 may be performed by welding in a state in which the electrode leads 111 pass through the coupling holes 221 and protrude outwardly of the bus bar 220.

The busbar assembly 200 may include a circuit member 230 to obtain information about temperature and/or voltage from the cell assembly 100 and/or the busbar 220. The circuit member 230 may include a flexible printed circuit board or a printed circuit board.

The busbar assembly 200 may include a connecting plate 240 for installing the circuit member 230. The connecting plate 240 may be disposed above the cell assembly 100. The connecting plate 240 may connect the busbar frames 210 at both ends of the cell assembly 100. The connecting plate 240 may be composed of a material that burns or melts at a preset temperature or higher when an event such as thermal runaway occurs. The connecting plate 240 may be formed of polypropylene that burns and/or melts at about 160° C. or PVC that burns and/or melts at about 170° C., but the material is not limited thereto. However, the connecting plate 240 is not an essential component, and it is also possible to install only the circuit member 230 without the connecting plate 240. The connecting plate 240 may include an auxiliary hole 241 having a shape similar to a shape of the venting hole 331 in a position corresponding to the venting hole 331 described below.

The module housing 300 may accommodate the cell assembly 100. For example, the module housing 300 may include an accommodation space to accommodate the cell assembly 100. To form the accommodation space, the module housing 300 may include a lower plate 310, a side plate 320, and an upper case 330. The lower plate 310, the side plate 320, and the upper case 330 may be combined with each other to form an accommodation space therein. In addition, the busbar assembly 200 may also be accommodated in the accommodation space. Therefore, the cell assembly 100 and the busbar assembly 200 may be accommodated together inside the accommodation space.

The upper case 330 may include at least one venting hole 331. The venting hole 331 may be a hole for discharging gas, flames, or foreign objects generated therefrom inside the module housing 300. The venting hole 331 may be a hole formed by perforating the upper case 330. The shape of the venting hole 331 may vary. For example, the venting hole 331 may include an oval shape. The venting holes 331 may be arranged in a row in the longitudinal direction (Y) of the battery cell 110. In addition, the venting holes 331 may be disposed in multiple rows along the stacking direction (X) of the battery cells 110. The size of the venting holes 331 may vary. For example, venting holes 331 having various lengths may be formed in the longitudinal direction (Y) of the battery cells 110. Referring to FIG. 1 and FIG. 2B, the venting holes 331 may include relatively short venting holes 331-1 and relatively long venting holes 331-2 in the longitudinal direction (Y) of the battery cells 110. However, the shape and arrangement direction of the venting holes 331 may be appropriately modified within the scope of the present purpose. For example, the venting holes 331 may be disposed in a single row in the stacking direction (X) of the battery cells 110 and may be disposed in multiple rows in the longitudinal direction (Y) of the battery cells 110.

The venting holes 331 may not overlap with the positions of the cell pads 120. For example, referring to FIGS. 4A and 4B, the venting holes 331 may not be located on the upper portion of the cell pads 120. Accordingly, the spaces on both sides of the cell pads 120 may not be connected by the venting holes 331. In detail, even if flames occur in a battery cell 110 on one side of the cell pads 120, the flames may not spread to the battery cell 110 on the other side through the venting holes 331.

The module housing 300 may include a venting flap case 400 covering a portion of an upper area of the upper case 330.

The venting flap case 400 may be a plate configured to cover a portion of an area of the upper case 330. The venting flap case 400 may be a plate having a thickness thinner than the thickness of the upper case 330. For example, the thickness of the upper case 330 of a general battery module 10 may be between 1.2 millimeters (mm) and 30 mm, and the venting flap case 400 may be formed to have a thickness of 0.01 mm or more and 3 mm or less, which is thinner than the upper case 330. More thinly, the venting flap case 400 may be a thin plate having a thickness of 0.01 mm or more and 0.1 mm or less. The thinner the venting flap case 400, the lower the weight of the battery module 10 or module housing 300, and the lower the manufacturing costs and the easier the manufacturing process.

The venting flap case 400 may include a material that may withstand high temperatures. For example, the venting flap case 400 may be applied with a material that does not melt at a high temperature of 400° C. or higher. Materials such as aluminum series, steel series, ceramic series, heat-resistant engineering plastic series, and carbon fiber reinforced plastic series may be used as the material, and the venting flap case 400 may include any one of the above materials.

The venting flap case 400 covers a portion of the upper case 330 and may be combined with the upper case 330. Various methods may be applied to the method by which the venting flap case 400 is combined with the upper case 330. For example, a fastening method using bolts/nuts, an adhesive method using structural adhesives, a welding method, a heat-melting method, a press-fit method, or the like may be applied. In the present disclosure, among various coupling methods, a welding coupling method is described as an example.

The venting flap case 400 may include at least one discharge portion 410.

The discharge portion 410 covers the venting hole 331 and may be configured to open the venting hole 331 by bending at least a portion thereof by pressure when an event occurs. For example, the discharge portion 410 may cover the venting hole 331 with a plate larger than the venting hole. The venting hole 331 may be blocked by the discharge portion 410. The event may mean a thermal runaway or thermal propagation situation of the battery module 10. Therefore, when an event occurs, gas may be generated or flames may occur inside the module housing 300. When an event occurs, the inside of the module housing 300 may be subjected to high pressure due to gas or flames. At this time, the high pressure gas or flames pushes up the discharge portion 410, and at least a portion of the discharge portion 410 is bent and the venting hole 331 is opened, so that the gas or flames may be discharged through the venting hole 331. At this time, foreign objects and the like generated by the flames inside thereof may be discharged together to the outside.

The discharge portion 410 may include a discharge plate 411, a folded portion 412, and a slit 414.

The discharge plate 411 covers the venting hole 331 and may be larger than the venting hole 331. The discharge plate 411 may be at least a portion of the venting flap case 400, which is a plate. Referring to FIG. 2A and FIG. 2B, the discharge plate 411 may be disposed at a position corresponding to the venting hole 331 to cover the venting hole 331. In this case, the discharge plate 411 may be formed larger than the venting hole 331 to block the venting hole 331. The discharge plate 411 may have various shapes. For example, the discharge plate 411 may have a quadrangular shape. Alternatively, the discharge plate 411 may have a shape corresponding to the venting hole 331. For example, when the venting hole 331 has an oval shape, the discharge plate 411 may also have an oval shape. Therefore, the quadrangular discharge plate 411 shape of the present disclosure is merely an example and is not necessarily limited thereto.

In addition, referring to FIG. 2A and FIG. 2B, the venting hole 331 may include a relatively short venting hole 331-1 and a relatively long venting hole 331-2, and the discharge portion 410 may include a relatively short discharge portion 410-1 and a relatively long discharge portion 410-2. The relatively long discharge portion 410-2 may cover the relatively long venting hole 331-2, and the relatively short discharge portion 410-1 may cover the relatively short venting hole 331-1.

Each discharge plate 411 is illustrated as covering one venting hole 331, but this is only an example, and it is also possible for one discharge plate 411 to cover multiple venting holes 331.

The folded portion 412 is provided on one side of the discharge plate 411 and may be configured to be bent to move the discharge plate 411. For example, the discharge plate 411 may be a portion formed by cutting or punching a certain area of the venting flap case 400. At this time, at least a portion of the periphery of the discharge plate 411 may be cut or punched, and the remaining portion that is not cut or punched may be the folded portion 412. For example, when the discharge plate 411 includes a quadrangular shape, a slit 414 cut or punched along three sides of the discharge plate 411 is formed, and the folded portion 412 may be provided on another one side. Accordingly, the discharge plate 411 may be connected to the venting flap case 400 via the folded portion 412. Referring to FIG. 4B, in an event situation, high-pressure gas or flames may push the discharge plate 411, and the folded portion 412 may be bent. As the folded portion 412 is bent, the discharge plate 411 may move as if rotating around the folded portion 412, and the venting hole 331 may be opened.

The folded portion 412 may be configured so that the angle (θ) formed by the discharge plate 411 and the upper case 330 when an event occurs is less than 90 degrees. Referring to FIG. 4B, when an event occurs, the folded portion 412 is bent, and the discharge plate 411 is rotated so that the discharge plate 411 and the upper case 330 may form a certain angle (θ). At this time, the angle (θ) may be less than 90 degrees. Accordingly, the path (F) through which gas, flames, or foreign objects are discharged may be formed at a smaller angle rather than being perpendicular to the upper case 330. For example, when viewed from the side, the path (F) through which gas, flame, or foreign matter is discharged may be formed diagonally based on the upper case 330. Since the discharged gas, flames or foreign matter is not discharged vertically to the upper case 330, it is expected that even if it collides with the external configuration of the battery module 10, such as the cover of the battery pack or the like, the discharged gas, flames or foreign matter will be prevented from being inserted into the vent hole 331 again.

The slit 414 may be formed by cutting or punching the perimeter of the discharge plate 411 except for the folded portion 412. In detail, the slit 414 may be a portion in which at least a portion of the venting flap case 400 is cut or punched to form the discharge plate 411. Referring to FIG. 2A, when the discharge plate 411 includes a quadrangular shape, the slit 414 may be formed along three sides of the discharge plate 411. At this time, the remaining side of the perimeter of the discharge plate 411, not cut or punched, may be the folded portion 412. In addition, adjacent discharge portions 410 may share at least a portion of the slits 414. For example, referring to FIG. 2A, the discharge portions 410 may be disposed in a row in the horizontal direction (Y). In this case, adjacent discharge portions 410 on the left and right may share a slit 414 in their middle. The slit 414 may be formed thicker than other slits 414. In detail, more portions may be cut or perforated. When adjacent discharge portions 410 share a slit 414, processing may be facilitated when forming a plurality of adjacent discharge portions 410.

The venting flap case 400 may include a welded portion 420 that is welded to the upper case 330. As described above, the venting flap case 400 may be joined to the upper case 330 in various ways, one of which may be welding. The welded portion 420 may be formed in a line along the folded portion 412 while being spaced apart from the folded portion 412. Referring to FIG. 2A, the welded portion 420 may be formed in parallel with the folded portion 412 while being spaced apart from the folded portion 412 by a certain distance. By forming the welded portion 420 at the corresponding location, the folded portion 412 may be bent while the venting flap case 400 is stably fixed to the upper case 330 when an event occurs.

The structure of the venting flap case 400 as described above may be referred to as a flap structure, and in detail, may be referred to as a flip structure. The venting flap case 400 may timely discharge gas, flame, or foreign objects inside the module housing 300 through the flap structure. When an event occurs, only the discharge portion 410 corresponding to the venting hole 331 where the event occurred may be opened. Accordingly, except for the opened discharge portion 410, the remaining discharge portions 410 may maintain a state of covering the venting hole 331. Accordingly, even if gas, flame, or foreign objects are discharged through the open discharge portion 410, the discharged gas, flame, or foreign objects may be prevented from entering the battery module 10 through other venting holes 331. For example, the battery module 10 or battery housing of the present disclosure may prevent the flames from spreading to other battery cells 110 or other battery modules 10 where the event did not occur.

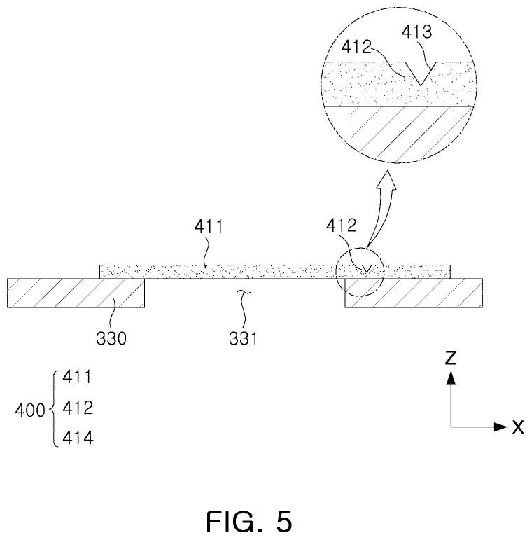

FIG. 5 is a cross-sectional view illustrating a portion of a cross-section taken along line I-I′ of FIG. 1.

Referring to FIG. 5, the folded portion 412 may further include a notched portion 413.

The folded portion 412 may further include a notched portion 413 in which at least a portion thereof is cut or punched to facilitate bending. When the notched portion 413 is formed in the folded portion 412, the thickness of the folded portion 412 may be formed thinner than the thickness of other portions of the venting flap case 400. Therefore, a relatively small force may be required to fold the folded portion 412. The force required for bending the folded portion 412 may be controlled by forming the notched portion 413. In detail, the pressure of the gas or flames discharged through the venting hole 331 may be measured, and the discharge portion 410 may be designed so that the discharge portion 410 may be opened at the corresponding pressure.

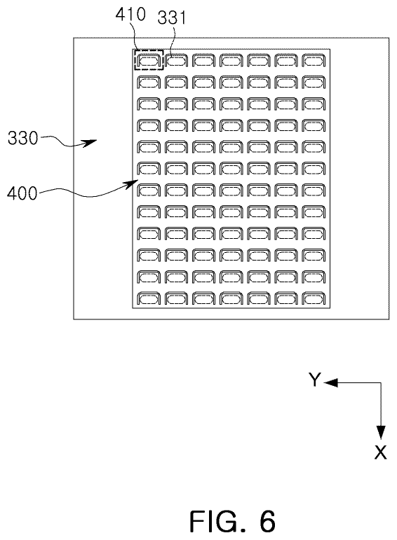

FIG. 6 is a plan view illustrating a modified example of the upper case 330 and the venting flap case 400.

Referring to FIG. 6, the venting holes 331 may respectively have the same size, and the discharge portions 410 may respectively have the same size.

For example, the lengths of the venting holes 331 in the horizontal direction (Y) may be the same, and correspondingly, the lengths of the discharge portions 410 in the horizontal direction (Y) may also be the same. This may be applied when the thickness of the venting flap case 400 is relatively thin. For example, when the thickness of the venting flap case 400 is less than or equal to 0.3 mm, the venting holes 331 may respectively have the same size, and the discharge portions 410 may respectively have the same size. When the thickness of the venting flap case 400 is less than or equal to 0.3 mm, each discharge portion 410 may be formed through a knife mold. For example, the slit 414 may be formed by cutting a portion of the venting flap case 400 using a knife. At this time, the width of the slit 414 may be formed to be less than 1 mm. When the thickness of the venting flap case 400 is less than or equal to 0.3 mm, the size of the discharge portion 410 may be limited for structural stability. Accordingly, respective lengths of the venting hole 331 and the discharge portion 410 may be reduced and formed to have the same size.

In comparison, referring to FIG. 2A and FIG. 2B, the venting hole 331 may include a relatively short venting hole 331a and a relatively long venting hole 331b, and the discharge portion 410 may include a relatively short discharge portion 410a and a relatively long discharge portion 410b. This may be applied when the thickness of the venting flap case 400 is greater than or equal to 0.3 mm. When the thickness of the venting flap case 400 is 0.3 mm or more, the discharge portion 410 may be formed by a press method. For example, the discharge portion 410 may be formed by punching a slit 414 in the venting flap case 400. At this time, the width of the slit 414 may be 3 mm or more. If the width of the slit 414 is 3 mm or less, the mass productivity of the venting flap case 400 may be reduced.

The above example is only an example, so the upper case 330 and the venting flap case 400 of the applied shape of FIG. 6 are not necessarily applied only to the venting flap case 400 having a thickness of 0.3 mm or less. Likewise, the upper case 330 and the venting flap case 400 of the applied shape of FIG. 2A and FIG. 2B are not necessarily applied only to the venting flap case 400 having a thickness of 0.3 mm or more.

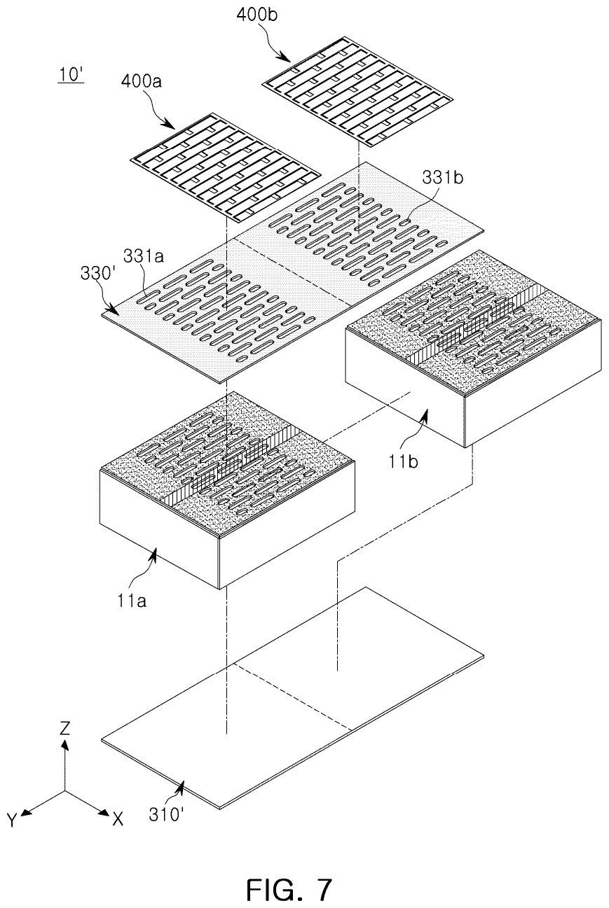

FIG. 7 is an exploded perspective view illustrating a battery module 10′ of another embodiment.

Referring to FIG. 7 and FIGS. 1 to 5 together, a battery module 10′ may include a first sub-module 11a, a second sub-module 11b, and a module housing 300. The sub-module 11 referred to here may be a sub-concept of the battery module 10′.

The first sub-module 11a and the second sub-module 11b may each include a cell assembly 100 including a plurality of battery cells 110 and a busbar assembly 200 electrically connecting the plurality of battery cells 110. For example, the first sub-module 11a and the second sub-module 11b may be similar to the structure of the battery module 10 described in FIGS. 1 to 5. In addition, the cell assembly 100 and the busbar assembly 200 may be the same as the cell assembly 100 and the busbar assembly 200 described above.

The module housing 300 may accommodate the first sub-module 11a and the second sub-module 11b, and may include an upper case 330′ and a venting flap case 400 covering a portion of the upper case 330′.

For example, the first sub-module 11a and the second sub-module 11b may be disposed side by side. The module housing 300 may further include a lower plate 310′ covering lower portions of the first sub-module 11a and the second sub-module 11b. For example, the lower plate 310′ may be formed to be long in the arrangement direction (Y) of the sub-modules 11 so that the first sub-module 11a and the second sub-module 11b may be stably seated. Correspondingly, the upper case 330′ may cover the upper portions of the first sub-module 11a and the second sub-module 11b. The upper case 330′ may also be formed to be long in the arrangement direction (Y). The upper case 330′ includes at least one venting hole 331, and the venting flap case 400 may include at least one discharge portion 410 covering the venting hole 331 and configured to open the venting hole 331 by bending at least a portion thereof by pressure when an event occurs.

The venting hole 331 may include a first venting hole 331a located on the upper side of the first sub-module 11a and a second venting hole 331b located on the upper side of the second sub-module 11b. For example, the first venting hole 331a may be disposed at a position corresponding to the first sub-module 11a, and the second venting hole 331b may be disposed at a position corresponding to the second sub-module 11b. The venting flap case 400 may include a first venting flap case 400a covering the first venting hole 331a and a second venting flap case 400b covering the second venting hole 331b. For example, the first venting hole 331a may be located at the upper portion of the first sub-module 11a, and the first venting flap case 400a may be located at the upper portion of the first venting hole 331a.

The configuration of the battery module 10′ of another embodiment may be similar to the configuration of the battery module 10 described in FIGS. 1 to 5. Therefore, the configuration of the battery module 10′ not described in FIG. 7 may be any one of the configurations of the battery module 10 described in FIGS. 1 to 5.

As set forth above, according to an embodiment, manufacturing and management costs of a battery module may be reduced.

According to an embodiment, gas, foreign objects, or the like generated in a thermal runaway or thermal propagation situation in a battery module may be discharged in a timely manner.

According to an embodiment, external foreign objects may be prevented from penetrating into a battery module through a venting hole.

Only specific examples of implementations of certain embodiments are described. Variations, improvements and enhancements of the disclosed embodiments and other embodiments may be made based on the disclosure of this patent document.

What is claimed is:

1. A battery module comprising:
a cell assembly including a plurality of battery cells;
a busbar assembly electrically connecting the plurality of battery cells; and
a module housing accommodating the cell assembly and including an upper case and a venting flap case covering a portion of an upper area of the upper case,
wherein the upper case includes at least one venting hole, and
the venting flap case includes at least one discharge portion covering the venting hole and configured to be at least partially bent by pressure when an event occurs and open the venting hole.

2. The battery module of claim 1, wherein the discharge portion includes,
a discharge plate covering the venting hole and larger than the venting hole;
a folded portion provided on one side of the discharge plate and configured to be bent to move the discharge plate; and
a slit provided by cutting or punching a perimeter of the discharge plate excluding the folded portion.

3. The battery module of claim 2, wherein the discharge plate includes a quadrangular shape,
the slit is provided along three sides of the discharge plate, and
the folded portion is provided on another one side.

4. The battery module of claim 2, wherein the folded portion further includes a notched portion at least partially cut or punched to facilitate bending.

5. The battery module of claim 2, wherein the folded portion is configured to be bent at an angle between the discharge plate and the upper case when the event occurs, less than 90 degrees.

6. The battery module of claim 2, wherein the venting flap case includes a welded portion welded to the upper case.

7. The battery module of claim 2, wherein the discharge portions adjacent to each other share at least a portion of the slit.

8. The battery module of claim 6, wherein the welded portion is spaced apart from the folded portion and formed in a line along the folded portion.

9. The battery module of claim 1, wherein the venting flap case includes any one of aluminum series, steel series, ceramic series, heat-resistant engineering plastic series and carbon fiber reinforced plastic series materials.

10. The battery module of claim 1, wherein a thickness of the venting flap case is 0.01 millimeters (mm) or more and 3 mm or less.

11. The battery module of claim 1, wherein the venting holes are respectively the same size, and
the discharge portions are respectively the same size.

12. The battery module of claim 1, wherein the venting hole includes a relatively short venting hole and a relatively long venting hole, and
the discharge portion includes a relatively short discharge portion and a relatively long discharge portion.

13. The battery module of claim 1, wherein the cell assembly further includes a blocking member disposed above the plurality of battery cells.

14. The battery module of claim 1, wherein the busbar assembly includes a connecting plate disposed above the cell assembly.

15. A battery module comprising:
a first sub-module and a second sub-module each including a cell assembly including a plurality of battery cells and a busbar assembly electrically connecting the plurality of battery cells; and
a module housing accommodating the first sub-module and the second sub-module, and including an upper case and a venting flap case covering a portion of an upper area of the upper case,
wherein the upper case includes at least one venting hole, and
the venting flap case includes at least one discharge portion covering the venting hole and configured to be at least partially bent by pressure when an event occurs and to open the venting hole.

16. The battery module of claim 15, wherein the module housing further includes a lower plate covering lower portions of the first sub-module and the second sub-module, and
the upper case covers upper portions of the first sub-module and the second sub-module.

17. The battery module of claim 16, wherein the venting hole includes a first venting hole located on an upper portion of the first sub-module and a second venting hole located on an upper portion of the second sub-module, and
the venting flap case includes a first venting flap case covering the first venting hole and a second venting flap case covering the second venting hole.

18. The battery module of claim 17, wherein the discharge portion includes,
a discharge plate covering the venting hole and being larger than the venting hole;
a folded portion provided on one side of the discharge plate and configured to be bent to move the discharge plate; and
a slit provided by cutting or punching a perimeter of the discharge plate excluding the folded portion.

19. A module housing comprising:
an upper case; and
a venting flap case covering a portion of an upper area of the upper case,
wherein the upper case includes at least one venting hole, and
the venting flap case includes at least one discharge portion covering the venting hole and configured to be at least partially bent by pressure when an event occurs and to open the venting hole.

20. The module housing of claim 19, wherein the discharge portion includes,
a discharge plate covering the venting hole and larger than the venting hole;
a folded portion provided on one side of the discharge plate and configured to be bent to move the discharge plate; and
a slit provided by cutting or punching a perimeter of the discharge plate excluding the folded portion.
